(19) United States
(12) Patent Application Publication
(10) Pub. No.: US 2007/0023967 A1
(43) Pub. Date: Feb. 1, 2007

(54) Device and process for cooling a core

(75) Inventors: Dominique Cordaillat, Brindas (FR); Stephane Beciu, Grigny (FR); Christian Vaillant, Greenville, SC (US)

Correspondence Address: Thomas Langer, Suite 1210, 551 Fifth Avenue, New York, NY, 10176, US

(73) Assignee: Michelin Recherche et Technique S.A., Granges-Paccot (CH)

(21) Appl. No.: 11/455,881

(22) Filed: Jun. 19, 2006

Related U.S. Application Data
(60) Provisional application No. 60/702,526, filed on Jul. 26, 2005.

(30) Foreign Application Priority Data
Jun. 17, 2005 (FR) 05/06243

(51) Int. Cl. B29C 35/00

(52) U.S. Cl. 264/326; 425/28.1

(57) ABSTRACT

A cooling device (230) for a core (N) composed of plural elements which may be dismantled and forming in the configuration used for the assembly a stable surface of revolution having a continuous form, close to the final form of manufacture of a tire, the core being used as a reference surface for the manufacture of the tires from the start of assembly through to vulcanization. The cooling device includes members for grasping and holding the core and members for setting the core in rotation about its axis rr′ placed in a horizontal position. A tub (233) is provided which contains refrigerated water, in which part of the surface of the core can be immersed.

### RELATED APPLICATIONS

This application claims priority from French application no. 05/06243 filed Jun. 17, 2005 and U.S. Provisional Patent Application Ser. No. 60/702,526 which was filed on Jul. 26, 2006.

### FIELD OF THE INVENTION

The invention relates to the manufacture of tires intended to equip vehicles and more particularly the arrangement of a machine intended for the manufacture of such tires.

### BACKGROUND OF THE INVENTION

A process and machine for the manufacture of tires are known from the prior art, such as described in the patent EP 0 666 165 B1, wherein the arrangement of the manufacturing stations is simplified, and wherein the entirety of devices for carrying out the assembly and vulcanisation stages is concentrated on one chassis acting as a single platform intended to receive the mechanical elements of the machine.

This manufacturing process uses a rigid core which may be dismantled and which partially imposes its shape on the tire. The core is formed of plural elements which are separable from one another and which form, once assembled, a stable surface of revolution used for manufacturing a tire, from assembly where it acts as a reference surface for the application of various components, through to vulcanisation where it forms the mould of the internal portion of the tire. When it is assembled, the core can be grasped by each of the faces of its central portion, forming a rim, so as to be transferred from one station to another.

The first manufacturing stage includes assembling the elements of the core and in positioning this in a station for assembling the components of the tire. The assembly stage includes depositing all the components of the tire consecutively on the core in a specified order of assembly. The whole is then transferred to a station in which the external moulding elements complement the core and is inserted into a vulcanisation chamber. Finally, after the stage of vulcanisation, the external mould and the core are removed from the tire and the elements of the core are cooled and re-assembled for the next cycle.

It has been found, nevertheless, that the temperature of the core after the re-assembly phase can still be too high to allow the depositing of rubber products on its surface. It therefore becomes necessary to cool the core before sending it back to an assembly station. The cooling means described in the patent EP 0 666 165 B1 includes placing the core in a chamber in which air is circulated.

Apart from the problem of noise generated by air turbulence, this device has the disadvantage of not allowing sufficiently rapid cooling of the core, which may hamper optimisation of the cycle times of a machine for tire manufacture such as described in the above-mentioned patent.

### SUMMARY OF THE INVENTION

One object of the invention is to provide a solution to the problem mentioned above and which includes carrying out cooling by immersing part of the surface of the core, previously set in rotation, in a tub of cooled water.

By combining the speed of rotation of the core, the depth of immersion, and the temperature of the cooled water, it is possible to reduce the temperature of the surface of the core in a relatively short time to a temperature which is compatible with the deposition of rubber products during the assembly stage following the cooling stage.

### BRIEF DESCRIPTION OF THE DRAWINGS

FIGS. 1 and 2 help to illustrate the description given below by being based on an embodiment of a machine according to the invention, and show:

FIG. 1, a diagrammatic perspective view of a cooling station according to the invention, and

FIG. 2, a diagrammatic perspective view of a particular configuration of use.

### DETAILED DESCRIPTION OF THE DRAWINGS

It is possible to refer to the publication EP 1 075 928 in order to obtain, in a non-limiting way, the detailed description of a rigid core comprising a connecting rim.

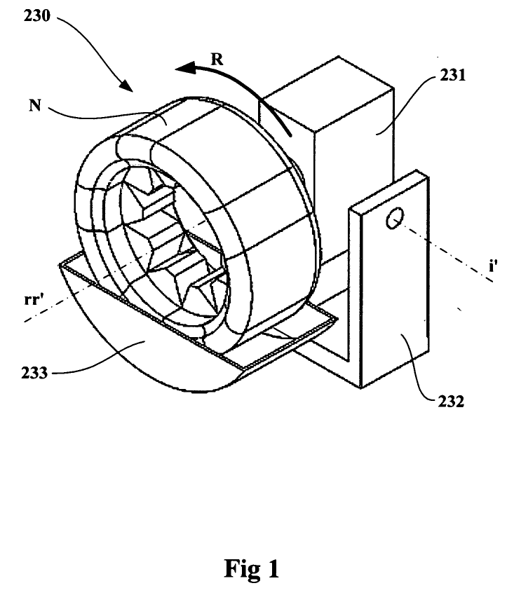

The cooling station 230, the detail of which is given in FIG. 1, comprises a frame 232 supporting a means 231 for grasping, holding and setting in rotation the core N about its axis of rotation rr′.

A tub 233 contains a specified volume of refrigerated water 234, in which the core is partially immersed. By setting the core in rotation in the direction of the arrow R, the entire surface of the core is immersed with each rotation. The fine coating of water deposited during immersion evaporates when the corresponding surface of the core passes through free air, which has the effect of accelerating heat dissipation.

In practice, the temperature reduction of the surface of the core which it is sought to achieve in a relatively short time is roughly about 70° C. to 100° C. It can be achieved in a time of less than 5 minutes.

In order to achieve this, a circumferential speed of the surface of between 2 and 5 m/s is selected. The temperature of the water is advantageously set between 20° C. and 50° C., and is preferably between 25° C. and 35° C. The depth of immersion is between 10 mm and 20 mm and may extend to 30 mm according to the diameter of the core. In order not to cause the parts of the core to deteriorate, the water contained in the tub is treated so as to avoid any deposit or other chemical attack.

The choice of parameters given above is determined according to the temperature of the core at the end of curing, the machine cycle time, and the desired surface temperature of the core at the start of the assembly cycle and associated with the materials deposited during the assembly cycle.

The core may be presented to the cooling station with its axis of rotation disposed in a horizontal position or in a vertical position. In the first case, it is necessary to equip the frame 232 with means for lowering or raising the core vertically in order to immerse the same in or withdraw it from the tub of cooled water.

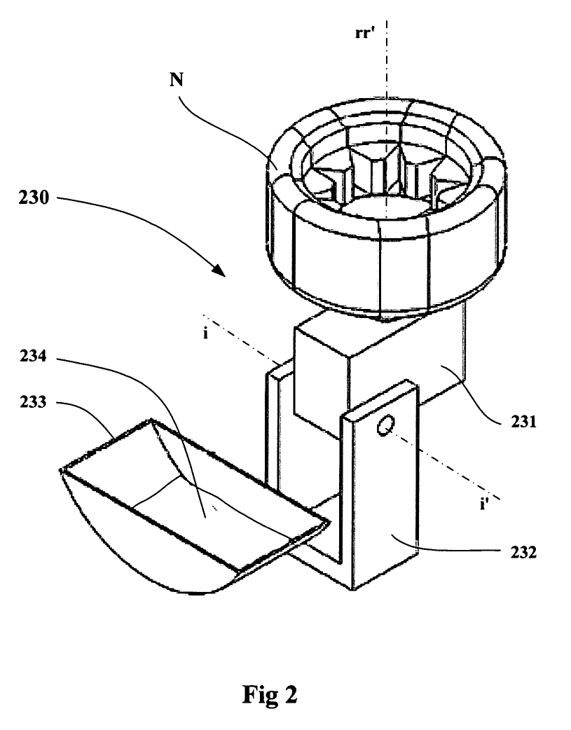

In the second case, it may be advantageous to articulate the means of holding the core 231 on the frame 232 about a horizontal axis ii′ as is shown in FIG. 2. By making the holding means 231 pivot about the axis ii′, it is possible to place the core in a first position in which the axis of rotation rr′ of the core is vertical, and in a second position in which the axis rr′ of the core is disposed horizontally. In this second position, it is arranged that the external surface of the core is partially immersed in the cooling water 234 contained in the tub 233.

When the temperature of the core reaches the desired value, the holding means 231 is raised or effects a rotation opposite to the previous one of 90° about the axis ii′ in order to return the axis rr′ of the core to a vertical position.

It is thus possible to evacuate the drops remaining on the surface of the core by centrifuging, by setting the core in high-speed rotation for several seconds. A circumferential speed of the surface of the core of between 7 m/s and 10 m/s is sufficient to evacuate only large drops. It has been found advantageous to retain on the surface of the core the smaller drops of water which evaporate during the time taken to transfer the core to the assembly station and which make it possible to extend the cooling time and to compensate for the effects of heat transfer taking place between the surface and the heart of the core during this lapse of time, whilst ensuring that the surface of the core is perfectly dry when the deposition of assembly products starts.

In determining the parameters of the cycle at the cooling station, the temperature differences which may exist between the surface and the heart of the core will be taken into account, which may cause a slight increase in surface temperature after the cooling stage proper. This temperature-homogenisation stage is produced during the time taken to transfer the core from the cooling station to the first assembly station, so as to obtain a stabilised temperature during the assembly stage.

This mode of cooling is preferred due to the speed at which it is possible to reduce the temperature of the core without creating a thermal shock. It will be noted that the fact of not totally immersing the core in the tub of water makes it possible to control mechanical deformation of the elements of the core.

The description of the cooling device of a core is based on a particular arrangement of this device in a whole assembly of devices intended for the assembly and vulcanisation of a tire. This particular implementation is in no way limiting, and a device according to the invention can be incorporated in different configurations.

We claim:

1. A device (230) for cooling a core (N) composed of plural elements capable of being dismantled and forming, in the configuration used for assembly, a stable surface of revolution having a continuous form, close to the final form of manufacture of a tire, the core being used as a reference surface for the manufacture of a tire from the start of assembly through to vulcanisation, such device comprising:
a means for grasping and holding the core;
means for setting the core in rotation about its axis rr′ placed in a horizontal position;
a tub (233) containing refrigerated water (234); and
means of immersing part of the surface of the core in the tub.

2. The cooling device according to claim 1, wherein the means (231) for grasping and holding the core is capable of pivoting about an axis ii′ in order to make the axis of rotation rr′ of the core move from a vertical position to a horizontal position and vice versa.

3. The cooling device according to claim 1, wherein the means (231) for grasping and holding the core is capable of effecting a vertical up-and-down movement.

4. A process for cooling a core (N) composed of plural elements capable of being dismantled and forming, in the configuration used for assembly, a stable surface of revolution having a continuous form, close to the final form of manufacture of a tire, the core being used as a reference surface for the manufacture of a tire from the start of assembly through to vulcanisation, wherein the process comprises:
cooling the core (N) by setting the core in rotation about a horizontal axis rr′ and by immersing part of the surface of the core in refrigerated water (234).

5. The cooling process according to claim 4, wherein the temperature of the water contained in the tub is between 20° C. and 50° C.

6. The cooling process according to claim 4, wherein the temperature of the water contained in the tub is between 25° C. and 35° C.

7. The cooling process according to claim 4, wherein the core (N) undergoes a reduction in temperature of between 70° C. and 100° C.

8. The cooling process according to claim 4, wherein the circumferential speed of the surface of the core is between 2 and 5 m/s during the immersion stage.

10. The cooling process according to claim 9, wherein the speed of rotation is adjusted in order to allow the evacuation only of large-diameter drops of water.

11. The cooling process according to claim 10, wherein the circumferential speed of the surface of the core is between 7 and 10 m/s.
